(19) United States
(12) Patent Application Publication
(10) Pub. No.: US 2008/0280020 A1
(43) Pub. Date: Nov. 13, 2008

(54) Process for Production of Soybean Puff

(76) Inventors: Hirofumi Kugitani, Tsukubamirai-shi (JP); Tetsuo Sakata, Izumisano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/886,158

(22) PCT Filed: Mar. 16, 2006
(86) PCT No.: PCT/JP2006/305208

§ 371 Date: Sep. 12, 2007

(30) Foreign Application Priority Data
Mar. 16, 2005 (JP) 2005-075386

(51) Int. Cl. A23L 1/212

(52) U.S. Cl. 426/634

(57) ABSTRACT

A process for producing a soybean puff comprising the steps of heating under pressure a water-bearing raw material comprising a soybean-derived defatted material and a starchy material and then extruding and expanding the resulting product to give the soybean puff, which process is characterized by the followings: (a) defatted soybean milk is the essential component of the soybean-derived defatted material; (b) the soybean-derived defatted material and the starchy material are used at the fractional ratios of 5 to 80 wt % (dry basis) and 20 to 95 wt % (dry basis), respectively; (c) the water-bearing raw material has a water content of 15 to 40 wt %; and (d) the temperature for the extrusion falls within the range of 130 to 200° C. The puff has an ingenuous taste for soybean and good feeling in the mouth.

### TECHNICAL FIELD

The present invention relates to a process for producing a soybean puff having an ingenuous taste of soybeans and a good feeling in the mouth.

### BACKGROUND ART

A light crispy puff snack is produced by frying a starchy material, or extruding a starchy material under increased pressure and heating with an extruder to puff out it. On the other hand, when a soybean material is extruded under increased pressure and heating with an extruder to cause it to be expanded, it is difficult to puff out the soybean material to such an extent as is attained by using a starchy material. In addition, since the product thus obtained contains mainly protein and therefore has meat-like texture, it has a meat-like feeling in the mouth when it is eaten after reconstruction in hot water or the like.

In recent years, soybeans have attracted attention as a health food, and therefore, demand for soybean protein, soybean peptide, soybean isoflavone, soybean milk and the like has been rapidly increased. Thus, how to eat a soybean material as easily as a puff snack has been studied. From a viewpoint of productivity, production of a puff by extrusion with an extruder is more efficient than by frying.

From a viewpoint of nutrient balance, a puff snack made from a starchy material contains mainly carbohydrate. On the other hand, a structured soybean protein obtained by puffing out a soybean material contains large amounts of a soybean protein, a physiologically active substance of a soybean and the like. However, a puff made from a soybean material using an extruder does not have a light feeling in the mouth.

Thus, in order to supplement the insufficient nutrition of a snack made from a starchy material and to improve the unsatisfactory mouth feel of a structured soybean protein, some attempts to use a soybean material and a starchy material in combination to produce a snack, cereal or puff have been made.

For example, the patent document 1 (JP-A 49-124243) discloses expanding grains, and also discloses that the surfaces of the expanded grains are coated with soybean powder together with a fat or an oil to produce a protein-enriched snack. The puff snack thus obtained, however, is not excellent in the soybean taste.

The patent document 2 (JP-A 1-23857) discloses a method of improving expansion of a soybean protein which comprises enzymatically degrading the soybean protein, because an oilseed protein such as a soybean protein is hard to swallow even after extrusion with an extruder. However, even though a soybean protein is enzymatically degraded, a puff snack having an excellent soybean taste is not obtained.

The patent document 3 (JP-A 5-192083) discloses that a bean material (a broad bean material obtained from a broad bean itself and its skin part) and a defatted soybean material are treated using an extruder, and the resulting expanded product is then subjected to an adhesion treatment of an oil. Also, a snack sufficiently having a taste peculiar to a bean such as a pea or a broad bean is disclosed. However, although the snack disclosed in the patent document 3 is excellent in the taste of a pea or a broad bean, it is not excellent in the soybean taste derived from a defatted soybean.

The patent document 4 (JP-A 59-51746) describes a combination of a bean material and a specific starchy material such as tapioca or the like. However, beans have an oil content of about 7% or more. When the oil content is high, it is difficult to expand a material after extrusion with an extruder and thus a crispy light feeling in the mouth is obtained with difficulty.

The patent document 5 (JP-A 61-289848) (invention of the present applicant) discloses that a cereal is produced by using a soybean protein material and grain or grain starch in combination. However, in the invention of the patent document 5, defatted soybean milk is not used, and a combination of defatted soybean milk and a defatted soybean is not used either.

The patent document 6 (JP-A 60-44504) discloses that a high-protein cereal is produced from a soybean protein and roasted grain or roasted grain starch. However, the high-protein cereal thus obtained has a stiff feeling in the mouth and does not have an ingenuous taste of soybeans.

The patent document 7 (JP-A 4-51849) discloses that a snack food is produced from a protein material and a starchy material.

However, the invention of the patent document 7 is for improving a feeling in the mouth by adding chloride and carbonate in combination, and its gist is different from that of the present invention.

The patent document 8 (JP-A 62-29936) discloses that a snack food is produced from starch and soybean protein.

However, the snack food thus obtained has no ingenuous taste of soybeans, and further has a special shape of a double spiral.

The patent document 9 (JP-A 10-234309) discloses that soybean milk is solidified once and then fried to produce a soybean protein-expanded food (snack). However, said food is produced by frying, but not by extrusion with an extruder. This is because soybean milk has a high oil content and therefore, even after extrusion with an extruder, the solidified soybean milk is difficult to expand to such an extent that a crispy light feeling in the mouth is obtained.

The patent document 10 (JP-A 58-216651) discloses that a snack is produced by adding water to a soybean protein followed by lyophilization. However, the snack thus obtained is not a puff snack, and does not have an ingenuous taste of soybeans.

As described above, any procedure is not necessarily satisfactory in respect to a feeling in the mouth, a taste and a production step, and does not provide a puff having an ingenuous taste of soybeans and a good feeling in the mouth.

### REFERENCES

Patent Document 1: JP-A 49-124243

Patent Document 2: JP-A 1-23857

Patent Document 3: JP-A 5-192083

Patent Document 4: JP-A 59-51746

Patent Document 5: JP-A 61-289848

Patent Document 6: JP-A 60-44504

Patent Document 7: JP-A 4-51849

Patent Document 8: JP-A 62-29936

Patent Document 9: JP-A 10-234309

Patent Document 10: JP-A 58-216651

### DISCLOSURE OF THE INVENTION

Problems to be solved by the Invention

Although a puff made from a starchy material has a good feeling in the mouth, it has insufficient nutrition. Although a puff made from a soybean material has sufficient nutrition, it has an unsatisfactory feeling in the mouth. Thus, some attempts to use a soybean material and a starchy material in combination to produce a snack, cereal or puff have been made. However, a satisfactory soybean puff having an ingenuous taste of soybeans and a good feeling in the mouth has never been obtained.

Thus, an objective of the present invention is to produce a soybean puff which contains the nutrient components of soybeans, has a crispy feeling in the mouth, is easy to swallow, and has an ingenuous taste of soybeans.

### Means for Solving the Problems

The present inventors intensively studied in order to solve the above problems. As a result, they have found that defatted soybean milk which is obtained by removing a bean curd refuse component from a defatted soybean remaining after extraction of an oil component from a soybean, instead of a soybean or an isolated soybean protein which is conventionally used, can be used in combination with a starchy material, and the raw material mixture can be then puffed out by extrusion under increased pressure and heating to produce a puff having an ingenuous taste of soybeans and a good feeling in the mouth, resulting in completion of the present invention.

The present invention is a process for producing a soybean puff which comprises extruding a water-bearing raw material comprising a defatted soybean-derived material and a starchy material under increased pressure and heating to cause the raw material to be expanded, wherein said process is characterized by that:
(a) the defatted soybean-derived material comprises defatted soybean milk as the essential component;
(b) the defatted soybean-derived material and the starchy material are used in a ratio of 5 to 80 parts by weight (dry matter basis):20 to 95 parts by weight (dry matter basis);
(c) the water-bearing raw material has a water content of 15 to 40 wt % ; and
(d) the heating temperature for extrusion falls within the range of 130 to 200° C.

It is preferable that 5 to 80 parts by weight (dry matter basis) of the defatted soybean milk is present in 100 parts by weight (dry matter basis) of a soybean puff raw material consisting of the defatted soybean-derived material and the starchy material.

It is preferable that the bulk specific gravity of the soybean puff is 0.05 to 0.35 g/ml.

### Effects of the Invention

According to the present invention, it is possible to produce a puff having the ingenuous taste of soybeans and a good feeling in the mouth.

### BEST MODE FOR CARRYING OUT THE INVENTION

First, “an ingenuous taste of soybeans” as used herein refers to a natural and plain taste having the sweetness and pleasant smell of soybeans, which does not have a raw smell and astringency such as raw beans have and which does not have a fragrant smell and bitterness such as roasted beans have.

The defatted soybean-derived material used in the present invention is suitably a material containing at least one selected from the group consisting of defatted soybean milk, a defatted soybean, a concentrated soybean protein, an isolated soybean protein, and products obtained by subjecting them to physical or chemical treatment, such as a ground product, an enzymatic degradation product and the like.

It is important for the defatted soybean-derived material to contain defatted soybean milk as the essential component.

When an expanded soybean puff having a firm feeling in the mouth is desired, it is preferable to use defatted soybean milk and a defatted soybean in combination.

This makes it possible to produce a puff having an ingenuous taste of soybeans and a good feeling in the mouth.

A whole soybean, commercially available soybean milk, or powdery soybean milk obtained by drying soybean milk is not defatted, and thus it contains an oil component. Therefore, even though a whole soybean, commercially available soybean milk or powdery soybean milk is subjected to the treatment with an extruder, an oil component contained in the raw material inhibits expansion, so that it is very difficult to obtain a puff which has a light feeling in the mouth and is easy to swallow.

In the present invention, it is important to use a raw material obtained from a defatted soybean.

It is difficult to obtain the desired soybean taste by using only a concentrated soybean protein or an isolated soybean protein.

In the case of using only a defatted soybean, a product has remarkable miscellaneous tastes although it has the soybean taste.

In order to obtain a soybean puff having an ingenuous taste of soybeans, use of defatted soybean milk is required. The defatted soybean milk may be used in combination with a concentrated soybean protein, an isolated soybean protein or a defatted soybean.

When the proportion of defatted soybean milk contained in the raw material is larger, an ingenuous taste of soybeans can be more efficiently imparted to the resulting soybean puff. Although the desired taste can be obtained by using defatted soybean milk alone, the resulting soybean puff may have a softened feeling in the mouth or may be insufficiently expanded, depending on the proportion of a starchy material contained in the raw material. Therefore, when a expanded soybean puff having a firm feeling in the mouth is desired, it is preferable to use defatted soybean milk in combination with other defatted soybean materials, and from a viewpoint of taste, texture and feeling in the mouth, it is preferable to use defatted soybean milk in combination with a defatted soybean.

For example, when defatted soybean milk is used in combination with a relatively low purified defatted soybean-derived material (defatted soybean etc.), miscellaneous tastes are produced. Therefore, preferably less than 50 parts by weight (dry matter basis), more preferably less than 30 parts by weight (dry matter basis) of a defatted soybean is present in 100 parts by weight (dry matter basis) of the puff raw material.

When defatted soybean milk is used in combination with a relatively highly purified defatted soybean-derived material (isolated soybean protein etc.), it is desirable to use an enzyme-treated product as the defatted soybean-derived material from a viewpoint of easy swallowing.

The starchy material used in the present invention can be selected from the group consisting of grain such as Amaranthus, foxtail millet, oat, barley, millet, wheat, rice, buckwheat, corn, job's tears, Japanese barnyard millet, sorghum, rye and the like; potatos and yams such as sunchoke, Amorphophallus konjac, sweet potato, aroid, aroid grown in a paddy field, taro, potato, Japanese yam, Chinese yam, Japanese yam shaped like a ginkgo leaf, propagule, jinenjyo (another name of Japanese yam), greater yam and the like; cassava, kudzu, sago, mung bean, azuki bean, common beam, pea, cowpea, broad bean, rice bean, chickpea, scarlet runner bean, rye bean, lentil and the like; unpurified and purified starch obtained from them, and processed starch obtained by subjecting said starch to a treatment such as gelatinization, roasting or hydrolysis, starch derivatives, alkali starch, fractionated starch, and physically treated starch derived from said starch, and the like; carboxymethylcellulose, methyl cellulose, carrageenan, guar gum, agar, sodium alginate and the like, and their mixtures.

For example, when starch derived from corn which is a kind of grain starch is used, highly-purified corn-derived starch such as corn starch is preferable to corn grits or the like because an ingenuous taste of soybeans can be more efficiently imparted to a puff when highly-purified corn-derived starch is used.

It is imperative that the defatted soybean-derived material containing defatted soybean milk as the essential component and the starchy material are used in a ratio of 5 to 80 parts by weight (dry matter basis):20 to 95 parts by weight (dry matter basis).

This is because when less than 20 parts by weight (dry matter basis) of the starchy material is present in 100 parts by weight (dry matter basis) of a puff raw material consisting of the defatted soybean-derived material containing defatted soybean milk as the essential component and the starchy material, it is hard to swallow a puff prepared from the raw material as dry matter, and when not less than 95 parts by weight (dry matter basis) of the starchy material is present in 100 parts by weight (dry matter basis) of the puff raw material, only less than 5 parts by weight (dry matter basis) of defatted soybean milk can be present in the puff raw material and therefore a puff prepared from the raw material has a decreased ingenuous taste of soybeans.

For imparting an ingenuous taste of soybeans to a puff, it is desirable that not less than 5 parts by weight (dry matter basis), more preferably not less than 15 parts by weight (dry matter basis) of defatted soybean milk is present in 100 parts by weight (dry matter basis) of the puff raw material.

Considering that a puff prepared from 100 parts by weight (dry matter basis) of the raw material comprising less than 20 parts by weight (dry matter basis) of the starchy material is hard to swallow as dry matter, as described above in respect of feeling in the mouth, however, it is preferable that 5 to 80 parts by weight (dry matter basis), preferably 15 to 80 parts by weight (dry matter basis) of defatted soybean milk is present in 100 parts by weight (dry matter basis) of the puff raw material.

In the present invention, in a step of extruding a water-bearing raw material comprising the defatted soybean-derived material and the starchy material under increased pressure and heating, the water content in the water-bearing raw material is essentially 15 to 40% by weight, preferably 16 to 33% by weight, more preferably 18 to 26% by weight.

When the water content in the water-bearing raw material is less than 15% by weight, the temperature of the water-bearing raw material rises to a high temperature and the resulting puff smells burnt, thus being not preferable. When the water content of the water-bearing raw material exceeds 40% by weight, the water-bearing raw material is insufficiently expanded and the resulting puff is hard to swallow, thus being not preferable. When the water content of the water-bearing raw material is 16 to 33% by weight, the resulting puff does not smell burnt and is easy to swallow, thus being preferable. When the water content of the water-bearing raw material is 18 to 26% by weight, the resulting puff is crispy, thus being more preferable.

Next, the temperature for extrusion in the present invention is suitably 130 to 200° C., preferably 140 to 190° C., more preferably 150 to 180° C., still more preferably 160 to 175° C.

When the extrusion temperature is lower than 130° C., the water-bearing raw material is insufficiently expanded and the resulting puff is hard to swallow, thus being not preferable. When the extrusion temperature exceeds 200° C., the resulting puff strongly smells burnt, thus being not preferable. At an extrusion temperature of 140 to 190° C., the resulting puff is easy to swallow, thus being preferable. At an extrusion temperature of 150 to 180° C., the resulting puff has an ingenuous taste of soybeans and is easy to swallow, thus being more preferable. At an extrusion temperature of 160 to 175° C., the resulting puff has an ingenuous taste of soybeans, does not smell burnt, and is crispy and easy to swallow, thus being still more preferable.

The soybean puff of the present invention has a crispy feeling in the mouth and is easy to swallow. The desirable extent of expansion of the soybean puff is such an extent that the bulk specific gravity of the soybean puff is suitably 0.05 to 0.35 g/ml, more preferably 0.05 to 0.25 g/ml, still more preferably 0.05 to 0.15 g/ml.

The lower limit of the bulk specific gravity is 0.05 g/ml. When the bulk specific gravity is below 0.05 g/ml, the soybean puff is crumbly in the dry state and therefore is difficult to handle as a commercial product although it has a satisfactory feeling in the mouth. When the bulk specific gravity exceeds 0.35 g/ml, the soybean puff has a too firm feeling in the mouth for being eaten as dry matter and is not easy to swallow. When the bulk specific gravity is not higher than 0.25 g/ml, the soybean puff is easy to swallow, thus being more preferable. When the bulk specific gravity is not higher than 0.15 g/ml, the soybean puff is crispy and easy to swallow, thus being still more preferable.

Meanwhile, in response to requirements of the extent of expansion, feeling in the mouth, nutrition and the like, an auxiliary material may be used to the extent that the gist of the present invention is not affected, if necessary. A protein which may be used as an auxiliary material can be selected from the group consisting of proteins derived from animals, plants and microorganisms, and their mixtures.

Examples of the protein derived from an animal include a milk protein, a whey protein, a protein derived from domestic animal meat, a fish protein, a plasma protein, a protein derived from a bird, a beast, a fish or a shellfish, gelatin, collagen and the like, an extract from them, a processed protein obtained from them, for example, lactalbumin, lactoglobulin, egg albumin, meat myosin, meat myogen, meat globulin, fish meat myoglobulin and the like, heat-treated, acid-treated, alkali-treated, and enzyme-treated proteins of them, and the like. Examples of the protein derived from a plant include proteins derived from oilseeds of pea, rapeseed, cottonseed, peanut, sesame, safflower, sunflower, corn, safflower, coconut and the like, or grain seeds of rice, barley, wheat and the like, extracted or processed proteins of them, for example, rice glutelin, barley prolamin, wheat prolamin, wheat gluten, peanut albumin and the like, heat-treated, acid-treated, alkali-treated, and enzyme-treated proteins of them, and the like. Examples of the protein derived from a microorganism include yeast and the like, unpurified, extracted and processed proteins of them, heat-treated, acid-treated, alkali-treated, and enzyme-treated proteins of them, and the like.

Another auxiliary material can be selected form the group consisting of known fillers, for example, foods such as chocolate, milk products and the like, polyhydric alcohol such as glycerin, monosaccharides to oligosaccharides such as sugar, glucose, lactose, sucrose, oligosaccharide, palatinose, coupling sugar, aspartame, glycyrrhiza, stevia, dextrin, isomerized sugar, raffinose, maltitol, sorbitol and glycerol, and their sugar alcohols, salts such as sodium chloride, bittern, chlorides of Na, K, Ca and Mg, and phosphates and citrates of Na and K, emulsifiers such as lecithin, sucrose fatty acid esters, monoglycerin fatty acid esters, polyglycerin fatty acid esters, sorbitan fatty acid esters, and propylene glycol fatty acid esters, food additives such as flavors and seasonings, and their mixtures.

The process of the present invention can be adjusted by changing the composition of a raw material by a known procedure conventionally used for producing a snack or a structured protein, for example, as described above, by using an alkaline earth metal salt such as Ca carbonate, egg shell Ca, Ca sulfate, Ca lactate, bittern or Mg chloride Mg, an organic acid or acid such as citric acid, sodium bicarbonate, an alkali, another auxiliary agent for expanding, a fat or an oil, or an emulsifier, or by changing a known factor such as the water content of a water-bearing raw-material, extrusion temperature or screw rotation number.

The bulk specific gravity (g/ml) of a sample was obtained by measuring the weight (W) of a sample when a 500 ml messcylinder was filled with 500 ml of the sample and then calculating using the following equation: Sample bulk specific gravity (g/ml)=W (g)/500 (ml).

As an extruder for extruding a raw material under increased pressure and heating which is used in the present invention, a known extruder can be used. Although a single screw extruder may be used in order to confirm a result or the like, it is preferable to use an extruder having two or more screws in order to attain stable expansion and discharge.

An extruder which can be used in the present invention has a raw material supplying port, a barrel through which a raw material is conveyed via a screw, mechanisms for mixing, pressurizing and heating a raw material in the barrel, and further, a die attached to the end of the barrel. Examples of a screw which can be placed in the extruder include a cut screw, a reverse cut screw, a kneading screw, a reverse kneading screw, a paddle screw and the like which have a kneading function, as well as a forward screw having a conveying function. In addition, a reverse screw, a spacer, a steam lock or the like may be placed in the extruder, if necessary.

The shape of the soybean puff is not particularly limited. When the soybean puff is eaten as it is as a snack, the soybean puff is preferably in the shape of a round, a rectangular round, a flat, a bar, a hollow body or a star which has the size that can be picked up by hand. When the soybean puff is kneaded in dough for a millet cake, a nutrient bar or the like for the purpose of addition of a nutrient, adjustment of bulk or improvement of feeling in the mouth, the soybean puff is preferably in the shape of a rice grain or a small grain. When the soybean puff is used as a cubic rice cracker for garnishing boiled rice with tea poured over it, a garnish for soup, a breakfast cereal or the like, the soybean puff is preferably in the shape of a small bar, a small horn or a small ring, and can be provided with water resistance by a known method such as coating with a fat or an oil having a high melting point, sugar or the like. If necessary, after extrusion, the soybean puff can be also shaped into a small flat by pressure. The soybean puff obtained by flattening with pressure after sufficient expanding can maintain a crispy feeling in the mouth, as compared with the soybean puff obtained by extruding a puff while the extent of expansion of the puff is suppressed for the purpose of increasing the specific gravity of the puff, followed by drying. In this way, the shape of the soybean puff can be freely selected depending on usage.

Although it is preferable to relish the soybean puff as it is, the soybean puff may be freely seasoned by a known method if necessary. A stimulative seasoning such as mustard may be used and, in this case, it is preferable that a thin layer of a stimulative seasoning is applied to the surface of the soybean puff. Thus, in the mouth, after a stimulative taste rapidly disappears, an ingenuous taste of soybeans gradually appears. However, it is not preferable to use a stimulative seasoning. It is preferable that an ingenuous and natural seasoning such as soft brown sugar, natto (fermented soybeans) powder, vegetable or root crop powder, or soy sauce is used so that an ingenuous taste of soybeans can be ensured.

### EXAMPLES

Embodiments of the present invention will be explained below with reference to Examples, which are merely illustrative and have no direct relationship to intension and extension of an idea.

(Hereinafter, raw materials used will be explained.)
Whole fat soybean powder: Whole soybeans are skinned, degermed, and ground. (Component: protein 40%, water 9%, lipid 23%)
Whole fat soybean milk powder: Soybean milk is prepared from whole soybeans, and then dried. (Component: protein 46%, water 6%, lipid 27%)
Defatted soybean powder: manufactured by Fuji Oil Co., Ltd. (Component: protein 52%, water 8%, lipid 0.8%)
Defatted soybean milk powder (Prepared soybean milk powder Soyafit 2000): manufactured by Fuji Oil Co., Ltd. (Component: protein 59%, water 6%, lipid 0.2%)
Bittern-free defatted soybean milk powder bittern-free: A bittern-free sample of Soyafit 2000 (Component: protein 60%, water 6%, lipid 0.2%)
Isolated soybean protein Fujipro E: manufactured by Fuji Oil Co., Ltd. (Component: protein 86%, water 6%,lipid 0.5%)
Isolated soybean protein Fujipro AL (an enzymatic degradation product of soybean protein): manufactured by Fuji Oil Co., Ltd. (Component: protein 86%, water 6%, lipid 0.5%)
Corn flour: a commercially available product (Component: protein 7%, water 13%, lipid 3%)
Corn starch: a commercially available product (Component: protein 0.3%, water 13%, lipid 0.7%)

### Example 1

According to the composition and condition of the following Table 1, Table 3 or Table 5, texturization was performed by a conventional method using a twin screw extruder under the following conditions.

Extruder used: Model KEI-45 twin screw extruder manufactured by Kowa-Kogyo Co., Ltd; L/D: 25; screw diameter: 45 mm.
Die used: 3 mm Φ×5 holes-face die; land: 5 mm.
Treatment amount: powdery raw material flow rate 30 kg/h.
Screw rotation number: 200 r.p.m.

The resulting discharged product was cut into about 1 cm length pieces with a rotary cutter immediately after exited from a die, and then dried with a hot air at 90° C. in a dryer manufactured by Tabai to attain to the water content of 5% by weight. The resulting puff sample was analyzed and assessed. Results are shown in the following Table 2, Table 4, Table 6 and Table 7.

TABLE 1

| | | | Water | |
|---|---|---|---|---|
| | | | content of | |
| | | | Water- | |
| | | | bearing | |
| Experimental | | Parts by | raw | Extrusion |
| No. | Raw material | weight | material | temp. |
| Comparative | Whole fat soybean | 50 parts | 21% | 170° C. |
| Example H1 | powder | | | |
| | Corn starch | 50 parts | | |
| Comparative | Whole fat soybean | 50 parts | 20% | 170° C. |
| Example H2 | milk powder | | | |
| | Corn starch | 50 parts | | |
| Comparative | Defatted soybean | 50 parts | 23% | 170° C. |
| Example H3 | powder | | | |
| | Corn starch | 50 parts | | |
| Comparative | Isolated soybean | 50 parts | 25% | 170° C. |
| Example H4 | protein Fujipro E | | | |
| | Corn starch | 50 parts | | |
| Comparative | Isolated soybean | 50 parts | 25% | 170° C. |
| Example H5 | protein Fujipro AL | | | |
| | Corn starch | 50 parts | | |
| Example A0 | Defatted soybean | 50 parts | 21% | 170° C. |
| | milk powder | | | |
| | (Bittern-free) | | | |
| | Corn starch | 50 parts | | |
| Example A1 | Defatted soybean | 50 parts | 21% | 170° C. |
| | milk powder | | | |
| | Corn starch | 50 parts | | |

TABLE 2

| Assessment | | Feeling in the | Initiation |
|---|---|---|---|
| No. | Taste of Sample | mouth of Sample | of Chewing |
| Comparative | Δ: Miscellaneous | X: Hard-to-swallow | Graunching |
| Example H1 | tastes | | |
| Comparative | ◯: A little | ΔX: Hard-to-swallow | Scrunching |
| Example H2 | ingenuous soybean | | |
| | taste | | |
| Comparative | Δ: Miscellaneous | ◯: A little | Crunching |
| Example H3 | tastes | easy-to-swallow | |
| Comparative | X: No soybean taste | Δ: Hard-to-swallow | Crunching |
| Example H4 | | | |
| Comparative | X: No soybean taste | ⊚: Easy-to-swallow | Crispy |
| Example H5 | | | |
| Example A0 | ◯⊚: Almost | ⊚: Easy-to-swallow | Crispy |
| | ingenuous soybean | | |
| | taste | | |
| Example A1 | ⊚: ingenuous | ⊚: Easy-to-swallow | Crispy |
| | soybean taste | | |

Since a whole soybean and whole fat soybean milk were not defatted, an oil component contained in the raw material inhibited expanding, resulting in insufficient expansion. In other words, it was extremely difficult to obtain a puff which had a light feeling in the mouth and was easy to swallow, and thus, the obtained puff had a stiff feeling in the mouth and was difficult to swallow.

When a raw material derived from a defatted soybean was used, the expansion state was better. However, when a defatted soybean was used alone, the resulting puff had remarkable miscellaneous tastes although it had the soybean taste. When a highly purified isolated soybean protein was used alone, the resulting puff had no ingenuous taste of soybeans, thus being not good.

When an enzymatically degraded soybean protein was used, the resulting soybean puff was crispy, but it had no ingenuous taste of soybeans. However, when defatted soybean milk was used, a soybean puff having the desired ingenuous soybean taste and having a good feeling in the mouth could be produced.

Although use of bittern-free defatted soybean milk produced the effect, use of adjusted soybean milk powder which was prepared using bittern (Soyafit 2000; manufactured by Fuji Oil Co., Ltd.) could more efficiently result in imparting of an ingenuous soybean taste to a puff.

TABLE 3

| | | | Water | |
|---|---|---|---|---|
| | | | content of | |
| | | | Water- | |
| | | | bearing | |
| Experimental | | Part by | raw | Extrusion |
| No. | Raw material | weight | material | temp. |
| Comparative | Defatted soybean | 50 parts | 42% | 136° C. |
| Example B1 | milk powder | | | |
| | Corn Starch | 50 parts | | |
| Example B2 | Defatted soybean | 50 parts | 31% | 158° C. |
| | milk powder | | | |
| | Corn Starch | 50 parts | | |
| Example A1 | Defatted soybean | 50 parts | 21% | 170° C. |
| | milk powder | | | |
| | Corn Starch | 50 parts | | |
| Example B3 | Defatted soybean | 50 parts | 17% | 176° C. |
| | milk powder | | | |
| | Corn Starch | 50 parts | | |
| Comparative | Defatted soybean | 50 parts | 14% | 185° C. |
| Example B4 | milk powder | | | |
| | Corn Starch | 50 parts | | |
| Example B5 | Defatted soybean | 50 parts | 21% | 170° C. |
| | milk powder | | | |
| | Corn starch | 50 parts | | |
| | Calcium carbonate | 0.5 parts | | |
| Example B6 | Defatted soybean | 10 parts | 32% | 158° C. |
| | milk powder | | | |
| | Defatted soybean | 40 parts | | |
| | powder | | | |
| | Corn starch | 50 parts | | |
| Example B7 | Defatted soybean | 10 parts | 32% | 158° C. |
| | milk powder | | | |
| | Defatted soybean | 40 parts | | |
| | powder | | | |
| | Corn starch | 50 parts | | |
| | Calcium carbonate | 1.5 parts | | |

TABLE 4

| | | Feeling in the | |
|---|---|---|---|
| Assessment | | mouth of | Initiation |
| No. | Taste of Sample | Sample | of Chewing |
| Example B1 | ⊚: Ingenuous soybean | ΔX: Hard-to- | Graunching |
| | taste | swallow | |
| Example B2 | ⊚: Ingenuous soybean | ◯: Easy-to-swallow | Crunching |
| | taste | | |
| Example A1 | ⊚: Ingenuous soybean | ⊚: Easy-to-swallow | Crispy |
| | taste | | |
| Example B3 | ◯: A little ingenuous | ⊚: Easy-to-swallow | Crispy |
| | soybean taste | | |
| | and | | |
| | A little cooked | | |
| | smell | | |
| Example B4 | ΔX: Burnt smell | □: Easy-to-swallow | Crispy |
| Example B5 | ⊚: Ingenuous soybean | ⊚: Easy-to-swallow | Crispy |
| | taste | | |
| Example B6 | ◯: Ingenuous soybean | Δ◯: A little | Graunching |
| | taste | easy-to-swallow | |
| | and | | |
| | Miscellaneous | | |
| | tastes of soybean | | |
| Example B7 | ◯: Ingenuous soybean | Δ◯: A little | Crumping |
| | taste | easy-to-swallow | |
| | and | | |
| | Miscellaneous | | |
| | tastes of soybean | | |

Note:
□ shows that a sample is crispy and easy to swallow, but the sample in the dry state is crumbly and is difficult to handle.

When the water content of a water-bearing raw material was less than 15% by weight, the temperature of the water-bearing raw material rose to a high temperature and the resulting puff smelled burnt, thus being not preferable. When the water content of a water-bearing raw material exceeded 40% by weight, the water-bearing raw material was insufficiently expanded and the resulting puff was hard to swallow, thus being not preferable.

When the water content of a water-bearing raw material was 16 to 33% by weight, the resulting puff did not smell burnt and was easy to swallow, thus being preferable. When the water content of the water-bearing raw material was 18 to 26% by weight, the resulting puff was crispy, thus being more preferable.

When the extrusion temperature was 140 to 190° C., the resulting puff was easy to swallow, thus being preferable. When the extrusion temperature was 150 to 180° C., the resulting puff had an ingenuous soybean taste and was easy to swallow, thus being more preferable. When the extrusion temperature was 160 to 175° C., the resulting puff had an ingenuous soybean taste, did not smell burnt, and was crispy and easy to swallow, thus being still more preferable.

TABLE 5

| | | | Water | |
|---|---|---|---|---|
| | | | content of | |
| | | | Water- | |
| | | | bearing | |
| Experimental | | Parts by | raw | Extrusion |
| No. | Raw material | weight | material | temp. |
| Example C1 | Defatted soybean milk | 3 parts | 19% | 170° C. |
| | powder | | | |
| | Corn starch | 97 parts | | |
| Example C2 | Defatted soybean milk | 5 parts | 19% | 169° C. |
| | powder | | | |
| | Corn starch | 95 parts | | |
| Example C3 | Defatted soybean milk | 20 parts | 20% | 170° C. |
| | powder | | | |
| | Corn starch | 80 parts | | |
| Example C4 | Defatted soybean milk | 20 parts | 20% | 169° C. |
| | powder | | | |
| | Corn flour | 80 parts | | |
| Example C5 | Defatted soybean milk | 20 parts | 23% | 170° C. |
| | powder | | | |
| | Isolated soybean | 30 parts | | |
| | protein Fujipro AL | | | |
| | Corn starch | 50 parts | | |
| Example C6 | Defatted soybean milk | 20 parts | 22% | 169° C. |
| | powder | | | |
| | Defatted soybean | 30 parts | | |
| | powder | | | |
| | Corn starch | 50 parts | | |
| Example A1 | Defatted soybean milk | 50 parts | 21% | 170° C. |
| | powder | | | |
| | Corn starch | 50 parts | | |
| Example C7 | Defatted soybean milk | 50 parts | 27% | 168° C. |
| | powder | | | |
| | Isolated soybean | 30 parts | | |
| | protein Fujipro AL | | | |
| | Corn starch | 20 parts | | |
| Example C8 | Defatted soybean milk | 80 parts | 27% | 170° C. |
| | powder | | | |
| | Corn starch | 20 parts | | |
| Example C9 | Defatted soybean milk | 95 parts | 29% | 171° C. |
| | powder | | | |
| | Corn starch | 5 parts | | |

TABLE 6

| | | Feeling in | |
|---|---|---|---|
| Assessment | | the mouth of | Initiation |
| No. | Taste of Sample | Sample | of Chewing |
| Example C1 | X: Less ingenuous | Δ: A little | Graunching |
| | soybean taste | hard-to-swallow | |
| Example C2 | ◯: A little ingenuous | Δ: A little | Graunching |
| | soybean taste | hard-to-swallow | |
| Example C3 | ⊚: Ingenuous soybean | ◯: Easy-to-swallow | Corunching |
| | taste | | |
| Example C4 | ◯⊚: Ingenuous | ⊚: Easy-to-swallow | Crispy |
| | soybean taste | | |
| | and | | |
| | Corn taste | | |
| Example C5 | ⊚: Ingenuous soybean | ⊚: Easy-to-swallow | Crispy |
| | taste | | |
| Example C6 | ◯: Ingenuous soybean | ◯: Easy-to-swallow | Crunching |
| | taste | | |
| | and | | |
| | A little | | |
| | miscellaneous | | |
| | tastes of soybean | | |
| Example A1 | ⊚: Ingenuous soybean | ⊚: Easy-to-swallow | Crispy |
| | taste | | |
| Example C7 | ⊚: Ingenuous soybean | ◯: A little | Crispy |
| | taste | easy-to-swallow | |
| Example C8 | ⊚: Ingenuous strong | Δ: A little | Crunching |
| | soybean taste | hard-to-swallow | |
| Example C9 | ⊚: Ingenuous strong | X: Hard-to-swallow | Crunching |
| | soybean taste | | |

When 5 parts by weight (dry matter basis) of a starchy material was present in 100 parts by weight (dry matter basis) of a puff raw material consisting of a defatted soybean-derived material and a starchy material, the resulting puff was hard to swallow, thus being not good.

From a viewpoint of easy swallowing, it was desirable that not less than 20 parts by weight (dry matter basis) of a starchy material was present in 100 parts by weight (dry matter basis) of the puff raw material. When not less than 95 parts by weight (dry matter basis) of a starchy material was present in 100 parts by weight (dry matter basis) of the puff raw material, only less than 5 parts by weight (dry matter basis) of defatted soybean milk could be present in the puff raw material and therefore the resulting puff had a decreased ingenuous taste of soybeans.

Therefore, it was preferable that the ratio of the defatted soybean-derived material to the starchy material was 5 to 80 parts by weight (dry matter basis):20 to 95 parts by weight (dry matter basis).

For imparting an ingenuous taste of soybeans to a puff, the amount of defatted soybean milk contained in the defatted soybean-derived material was determined to be desirably such an amount that not less than 5 parts by weight (dry matter basis), more preferably not less than 15 parts by weight (dry matter basis) of defatted soybean milk could be present in 100 parts by weight (dry matter basis) of the puff raw material.

Considering that a puff prepared from 100 parts by weight (dry matter basis) of the puff raw material comprising less than 20 parts by weight (dry matter basis) of a starchy material was hard to swallow as dry matter, as described above in respect of feeling in the mouth, however, it is preferable that 5 to 80 parts by weight (dry matter basis), preferably 15 to 80 parts by weight (dry matter basis) of defatted soybean milk is present in 100 parts by weight (dry matter basis) of the puff raw material.

If the defatted soybean-derived material contains a defatted soybean-derived material other than defatted soybean milk in combination with defatted soybean milk for the purpose of responding to a demand for imparting of a physical property such as a crunchy feeling in the mouth, a demand for enhancement of nutrition, for example, a demand for increase in the soybean protein content or a demand for incorporation of a large amount of dietary fiber derived from soybeans or a physiologically active substance such as saponin or isoflavone, or a demand for both enhancement of nutrition and imparting of a physical property, for example, a demand for increase in the soybean protein content and imparting of a crispy feeling in the mouth, it is preferable that 5 to 80 parts by weight (dry matter basis), preferably 15 to 80 parts by weight (dry matter basis) of defatted soybean milk is present in 100 parts by weight (dry matter basis) of the puff raw material.

TABLE 7
Comparison between bulk specific gravity and
feeling in the mouth of sample

| | | | Bulk specific |
|---|---|---|---|
| Assessment | Feeling in the mouth of | Initiation of | gravity of Sample |
| No. | Sample | Chewing | (g/ml) |
| Example B1 | ΔX: A little | Graunching | 0.36 |
| | hard-to-swallow | | |
| Example B2 | ◯: Easy-to-swallow | Crunching | 0.25 |
| Example A1 | ⊚: Easy-to-swallow | Crispy | 0.15 |
| Example B3 | ⊚: Easy-to-swallow | Crispy | 0.10 |
| Example B4 | □: Easy-to-swallow | Crispy | 0.04 |

Note:
□ shows that a sample is crispy and easy to swallow, but the sample in the dry state is crumbly and is difficult to handle.

The soybean puffs as shown above were crispy and easy to swallow, and however, it was determined that the desirable extent of expansion was such an extent that the bulk specific gravity of the soybean puff was suitably 0.05 to 0.35 g/ml, more preferably 0.05 to 0.25 g/ml, still more preferably 0.05 to 0.15 g/ml.

The lower limit of the bulk specific gravity was 0.05 g/ml. When the bulk specific gravity was below 0.05 g/ml, the resulting soybean puff was crumbly in the dry state and therefore was difficult to handle as a commercial product although it had a satisfactory feeling in the mouth. When the bulk specific gravity exceeded 0.35 g/ml, the resulting soybean puff had a too firm feeling in the mouth for being eaten as dry matter and was not easy to swallow. When the bulk specific gravity was not higher than 0.25 g/ml, the resulting soybean puff was easy to swallow, thus being more preferable. When the bulk specific gravity was not higher than 0.15 g/ml, the resulting soybean puff was crispy and easy to swallow, thus being still more preferable.

### INDUSTRIAL APPLICABILITY

According to the present invention, it is possible to produce a puff having an ingenuous taste of soybeans and a good feeling in the mouth.

According to the present invention, the objective soybean puff can be produced continuously and stably on a large scale by using an extruder for producing a structured soybean protein or a snack which is industrially in widespread use, without using a lyophilization method or a frying method.

1. A process for producing a soybean puff which comprises extruding a water-bearing raw material comprising a defatted soybean-derived material and a starchy material under increased pressure and heating to cause the raw material to be expanded, wherein said process is characterized by that:
(a) the defatted soybean-derived material comprises defatted soybean milk as the essential component;
(b) the defatted soybean-derived material and the starchy material are used in a ratio of 5 to 80 parts by weight (dry matter basis):20 to 95 parts by weight (dry matter basis);
(c) the water-bearing raw material has a water content of 15 to 40 wt % ; and
(d) the heating temperature for extrusion falls within the range of 130 to 200° C.

2. The process according to claim 1, wherein 5 to 80 parts by weight (dry matter basis) of the defatted soybean milk is present in 100 parts by weight (dry matter basis) of a soybean puff raw material consisting of the defatted soybean-derived material and the starchy material.

3. The process according to claim 1, wherein the bulk specific gravity of the soybean puff is 0.05 to 0.35 g/ml.

4. The process according to claim 2, wherein the bulk specific gravity of the soybean puff is 0.05 to 0.35 g/ml.
